(19) United States
(12) Patent Application Publication
(10) Pub. No.: US 2016/0378744 A1
(43) Pub. Date: Dec. 29, 2016

(54) TEXT INPUT METHOD AND DEVICE

(71) Applicant: Xiaomi Inc., Beijing (CN)

(72) Inventors: Fei XiangLi, Beijing (CN); Zhuang Qian, Beijing (CN); Baoke Chen, Beijing (CN)

(21) Appl. No.: 15/091,553

(22) Filed: Apr. 5, 2016

(30) Foreign Application Priority Data
Jun. 25, 2015 (CN) 201510359814.9

(51) Int. Cl. G06F 17/27; G06F 3/0484; G06F 3/0482; G06F 17/24

(52) U.S. Cl. CPC G06F 17/276; G06F 17/24; G06F 3/04847; G06F 3/0482; G06F 3/04842

(57) ABSTRACT

A method for inputting text into a text entry box is provided. The method includes: displaying the text entry box and judging whether a preset string quick-input mode is activated for characters to be typed into the text entry box; detecting whether a preset operation with respect to a preset character is received via a character input interface, in response to judging that the preset string quick-input mode is activated; and retrieving a preset string and inputting the preset string into the text entry box, in response to detecting that the preset operation with respect to the preset character is received. Herein a correspondence between the preset string and the preset operation with respect to the preset character is defined in the preset string quick-input mode.

### CROSS-REFERENCE TO RELATED APPLICATIONS

This application is based upon and claims priority to Chinese Patent Application 201510359814.9, filed Jun. 25, 2015, the entire contents of which are incorporated herein by reference.

### TECHNICAL FIELD

The present disclosure generally relates to field of communication, and more particularly, to a method and a device for inputting text into a text entry box.

### BACKGROUND

With development of smart devices, the smart devices with large screens become more and more popular. However, although the smart devices with large screens are excellent for a user to browse webpages/pictures and watch videos, with more and more applications installed in the smart devices, it is necessary to further optimize the smart devices.

### SUMMARY

According to a first aspect of embodiments of the present disclosure, there is provided a method for inputting text into a text entry box, including: displaying the text entry box and judging whether a preset string quick-input mode is activated for characters to be typed into the text entry box; detecting whether a preset operation with respect to a preset character is received via a character input interface, in response to judging that the preset string quick-input mode is activated; and retrieving a preset string and inputting the preset string into the text entry box, in response to detecting that the preset operation with respect to the preset character is received, wherein a correspondence between the preset string and the preset operation with respect to the preset character is defined in the preset string quick-input mode.

According to a second aspect of embodiments of the present disclosure, there is provided a device for inputting text into a text entry box, including: a processor; and a memory for storing instructions executable by the processor, wherein the processor is configured to perform: displaying the text entry box and judging whether a preset string quick-input mode is activated for characters to be typed into the text entry box; detecting whether a preset operation with respect to a preset character is received via a character input interface, in response to judging that the preset string quick-input mode is activated; and retrieving a preset string and inputting the preset string into the text entry box, in response to detecting that the preset operation with respect to the preset character is received, wherein a correspondence between the preset string and the preset operation with respect to the preset character is defined in the preset string quick-input mode.

According to a third aspect of the embodiments of the present disclosure, there is provided a non-transitory computer-readable storage medium including instructions, executable by a processor in a device, for performing a method for inputting text into a text entry box, the method including: displaying the text entry box and judging whether a preset string quick-input mode is activated for characters to be typed into the text entry box; detecting whether a preset operation with respect to a preset character is received via a character input interface, in response to judging that the preset string quick-input mode is activated; and retrieving a preset string and inputting the preset string into the text entry box, in response to detecting that the preset operation with respect to the preset character is received, wherein a correspondence between the preset string and the preset operation with respect to the preset character is defined in the preset string quick-input mode.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for inputting text, according to an exemplary embodiment.

FIG. 2 is a flow chart of another method for inputting text, according to an exemplary embodiment.

FIG. 3 is a schematic diagram of setting a string quick-input mode, according to an exemplary embodiment.

FIG. 4 is a block diagram of a text input device, according to an exemplary embodiment.

FIG. 5 is a block diagram of another text input device, according to an exemplary embodiment.

FIG. 6 is a block diagram of yet another text input device, according to an exemplary embodiment.

FIG. 7 is a block diagram of a text input device, according to an exemplary embodiment.

FIG. 8 is a block diagram of another text input device, according to an exemplary embodiment.

FIG. 9 is a block diagram of yet another text input device, according to an exemplary embodiment.

FIG. 10 is a block diagram of still yet another text input device, according to an exemplary embodiment.

FIG. 11 is a block schematic diagram of a device for inputting text into a text entry box, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The terms used in the present disclosure only tend to depict specific embodiments, rather than restricting the present disclosure. Unless the exceptional case in which the context clearly gives supports, the singular forms “a”, “an”, and “the” used in the present disclosure and accompany claims are intended to include the plural forms. It should also be appreciated that the expression “and/or” used herein indicates including any and all possible combinations of one or more of the associated listed items.

It should be understood, although terms first, second, third and the like are used in the present disclosure to depict various information, such information is not restricted by these terms. These terms are only used to distinguish information of the same type from each other. For example, without departing from the scope of the present disclosure, the first information may also be referred to as the second information. Similarly, the second information may also be referred to as the first information. Depending on context, the word “if” used herein may be explained to “when” or “upon” or “in response to determining . . . ”.

During daily usage of a smart device with a large screen, the user often needs to repeatedly input some relatively long text with a lot of characters. For example, when logging in some applications installed in a smart device, the user generally uses an email address as a login account of the user, therefore, it is a scenario of text input encountered by all users every day that the user inputs an email address via an input method. In such scenario, if the user uses a uniform login account in various applications, he/she often needs to repeatedly input the same email address.

In order to provide users with convenience when inputting text, in the related art, a function of “text favorites folder” has been introduced in the input method, and the user may save several frequently-used words and/or phases in the “text favorites folder”. In this way, when needing to input a relevant word and/or phase, the word and/or phase may be directly selected from the text favorites folder. However, in such solution, in general, an application interface of the text favorites folder is deep, and is not intuitive enough, and the number of the frequently-used phrases saved in the text favorites folder is generally very large, which is inconvenient for the user to look up an interested phrase, thereby decreasing the popularity.

Therefore, the present disclosure provides a method for inputting text. According to the present disclosure, the text entry box is displayed and whether a preset string quick-input mode is activated for characters to be typed into the text entry box is judged as a first step. Then whether a preset operation with respect to a preset character is received via a character input interface is detected in response to judging that the preset string quick-input mode is activated. Finally, a preset string is retrieved and the preset string is input into the text entry box in response to detecting that the preset operation with respect to the preset character is received. Herein a correspondence between the preset string and the preset operation with respect to the preset character is defined in the preset string quick-input mode. In this way, the user may quickly input a relatively long text by utilizing the preset character through the character input interface. Accordingly, the operational complexity of using the input method of a mobile terminal is relieved, and thus the text input experience of the user is improved.

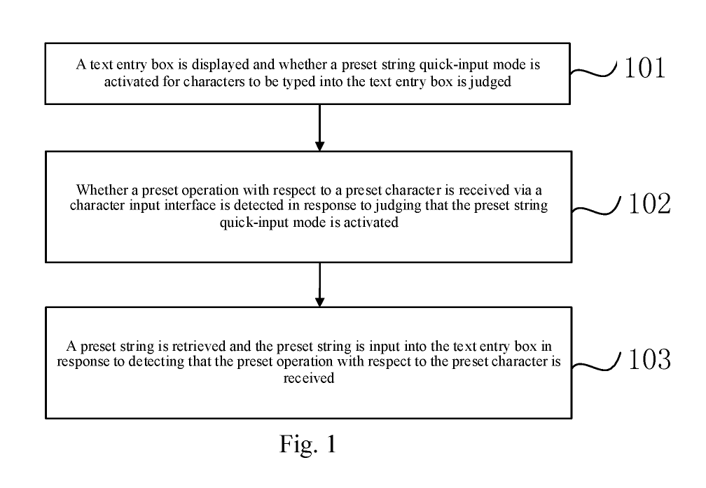

FIG. 1 is a flow chart of a method for inputting text, according to an exemplary embodiment. As shown in FIG. 1, the method for inputting text is implemented by a terminal device, and includes the following steps.

In step 101, a text entry box is displayed and whether a preset string quick-input mode is activated for characters to be typed into the text entry box is judged.

In step 102, whether a preset operation with respect to a preset character is received via a character input interface is detected in response to judging that the preset string quick-input mode is activated.

In step 103, a preset string is retrieved and the preset string is input into the text entry box in response to detecting that the preset operation with respect to the preset character is received. Herein a correspondence between the preset string and the preset operation with respect to the preset character is defined in the preset string quick-input mode.

In the present embodiment, the terminal device may be a mobile terminal of a user. For example, the mobile terminal may be a smart mobile phone, a tablet computer, and the like of the user. The character input interface may be an input interface on the mobile terminal, for example, may be a virtual on-screen keyboard on the smart mobile phone.

During usage of the mobile terminal, if the user needs to input a character or text in a system interface, he/she may generally load a virtual on-screen keyboard on the mobile terminal, then input the character or text by operating the virtual on-screen keyboard. However, in course of using the mobile terminal daily, the user may often repeatedly input some relatively long text including a lot of characters. For example, if the user uses an email address as a uniform login account of various applications in the mobile terminal, then during daily usage, the user may often need to repeatedly input the same email address.

Thereby, in such usage scenario, the requirement on repeatedly input some same text may affect the user experience. Moreover, when the user carries out inputting by operating the virtual on-screen keyboard, problems of uncorrect input or poor input experience may be occurred due to limitation of hardware conditions. For example, as to the mobile terminal with a relatively small screen, when inputting by using the virtual on-screen keyboard, the user may input mistakenly due to a relatively small size of the virtual on-screen keyboard. As to the mobile terminal with a large screen, since generally a smooth glass screen is adopted for enhancing a viewing experience of the user when browsing webpages, pictures, and videos, the input experience is poor when the user inputs a relatively long text by operating the virtual on-screen keyboard on the mobile terminal with a large screen.

In order to solve the above problems, a string quick-input mode may be preset in an interface for setting a system input method (i.e., a system input method setting interface) on the mobile terminal. Accordingly, a preset string needing to be quickly inputted and a preset character, which are set by the user in the string quick-input mode, are acquired. In this way, when the user performs a preset operation with respect to the preset character on the virtual on-screen keyboard, the system may be automatically triggered to input the preset string set by the user in the string quick-input mode into an input box, thereby the user may quickly input the preset string by only typing the designated character on the virtual on-screen keyboard.

In the present embodiment, in order to activate the string quick-input mode, a function option of activating the string quick-input mode may be preset via the system input method setting interface, and the user may activate the string quick-input mode by setting the function option. For example, as to the mobile terminal with a touch-screen, the user may click and set the function option via the system input method setting interface, so as to activate the string quick-input mode.

Hereinafter, detailed explanations will be given by using an example in which the above function is achieved in a mobile terminal with a touch-screen. Certainly, achieving the above function in the mobile terminal with a touch-screen is only illustrative, and in actual applications, equal implementations may be carried out on a mobile terminal with a non-touch screen according to the following detailed implementing procedure.

When implementing on the mobile terminal with a touch-screen, the mobile terminal may monitor in a background in real time a touch event with respect to the function option via the system input method setting interface by a user. When a touch event with respect to the function option by the user is monitored, the mobile terminal may determine in the background that the string quick-input mode has been set at present, and thus the string quick-input mode may be started/activated.

After the mobile terminal starts the string quick-input mode in the background, the user may set a preset string needing to be quickly inputted via the system input method setting interface, at the same time, the mobile terminal may, in the background, receive in real time a string inputted by the user via the system input method setting interface, and set the received string as the preset string in the string quick-input mode.

When the user sets the preset string via the system input method setting interface, the mobile terminal may provide a preset string-input box via the system input method setting interface for the user, and the user may input a string in the string-input box, then the mobile terminal may acquire the string inputted in the string-input box by the user, and then set the acquired string as the preset string in the string quick-input mode in the background.

Certainly, during implementation, the user may also set a plurality of preset strings via the system input method setting interface. For example, in case of inputting a plurality of strings in the above string-input box, when continuously inputting the multiple strings, the user may separate the continuously inputted multiple strings by specific separator characters, such as “;”. Accordingly, when the mobile terminal acquires the strings inputted by the user in the background, the mobile terminal may automatically identify the strings inputted by the user to be multiple according to the separator characters.

In the present embodiment, in addition to setting the string needing to be quickly inputted in the string quick-input mode via the system input method setting interface, the user may also set a preset character for triggering the string quick-input mode via the system input method setting interface.

When the user sets a preset character for triggering the string quick-input via the system input method setting interface, the mobile terminal may provide for the user with a first setting option for setting the preset character via the system input method setting interface.

During implementation, the first setting option may be a preset character list, in which several preset characters may be included. When setting the preset character, the user may directly select a preset character needing to be set from the preset character list, and at the same time, the mobile terminal may acquire the character selected by the user from the preset character list, and set the acquired character as the preset character for triggering the string quick-input in the background.

The preset characters in the preset character list may be selected from the virtual on-screen keyboard randomly, or may be obtained based on an input habit of the user and a keyboard layout of the virtual on-screen keyboard. For example, as to the mobile terminal with a touch-screen, the mobile terminal collects touching points by the user during usage of the terminal device in the background, then analyze the usage habit of the user in the background according to the touching points of the user, for example, on basis of coordinates of the collected touching points, whether the user is used to operate by left hand or operate by right hand may be analyzed. When the mobile terminal analyzes the usage habit of the user in the background, the keyboard layout on the virtual on-screen keyboard may be read out, and in combination with the usage habit of the user, characters which are more suitable for the usage habit of the user are read out from the virtual on-screen keyboard and are putted into the above preset character list for selection by the user. For example, assuming that the mobile terminal analyzes that the user is a left-hand user, then the characters to the left side on the layout of the virtual on-screen keyboard may be putted into the above preset character list for selection by the user, in this way, when the user sets the preset characters in the string quick-input mode, the usage habit of the user may be sufficiently adapted.

In the present embodiment, in addition to setting the strings needing to be quickly inputted in the string quick-input mode and the preset character via the system input method setting interface, the user may also set a preset operation for triggering the string quick-input via the system input method setting interface.

When the user sets a preset operation for triggering the string quick-input via the system input method setting interface, the mobile terminal may provide for the user with a second setting option for setting the preset operation via the system input method setting interface.

During implementation, the second setting option may be a preset operation list, in which several preset operations may be included. For example, the several preset operations may include a long-press operation, a double-click operation, and the like. When setting the preset operation, the user may directly select a preset operation needing to be set from the preset operation list. At the same time, the mobile terminal may, in the background, acquire the operation selected by the user from the preset operation list, and set the acquired operation as the preset operation for triggering the string quick-input.

In the present embodiment, a confirmation option may be included via the system input method setting interface. For example, the confirmation option may be a confirmation button. After the user respectively sets the preset string, the preset character and the preset operation via the system input method setting interface, confirmation may be set by clicking the confirmation button upon the complete of the setting.

After the user sets the confirmation by clicking the confirmation button to start the string quick-input mode, the mobile terminal may, in the background, detect in real time an operation with respect to the virtual on-screen keyboard by the user, and judge whether the detected operation is a preset operation (such as a long-press operation) with respect to a preset character(such as the character “A”) on the virtual on-screen keyboard by the user. If the detected operation is a preset operation with respect to a preset character on the virtual on-screen keyboard, the mobile terminal may be triggered to retrieve the preset string which has been set by the user, and quickly input the preset string into a text entry box in the background.

By this way, the user may quickly input the preset string set in the string quick-input mode by performing a preset operation to a designated character on the virtual on-screen keyboard, thereby improving the text input experience of the user.

In the above embodiments, the user may utilize the preset characters in the character input interface to quickly input a relatively long text, reduce the complexity of operation when using the input method of the mobile terminal, and thereby improve the text input experience of the user.

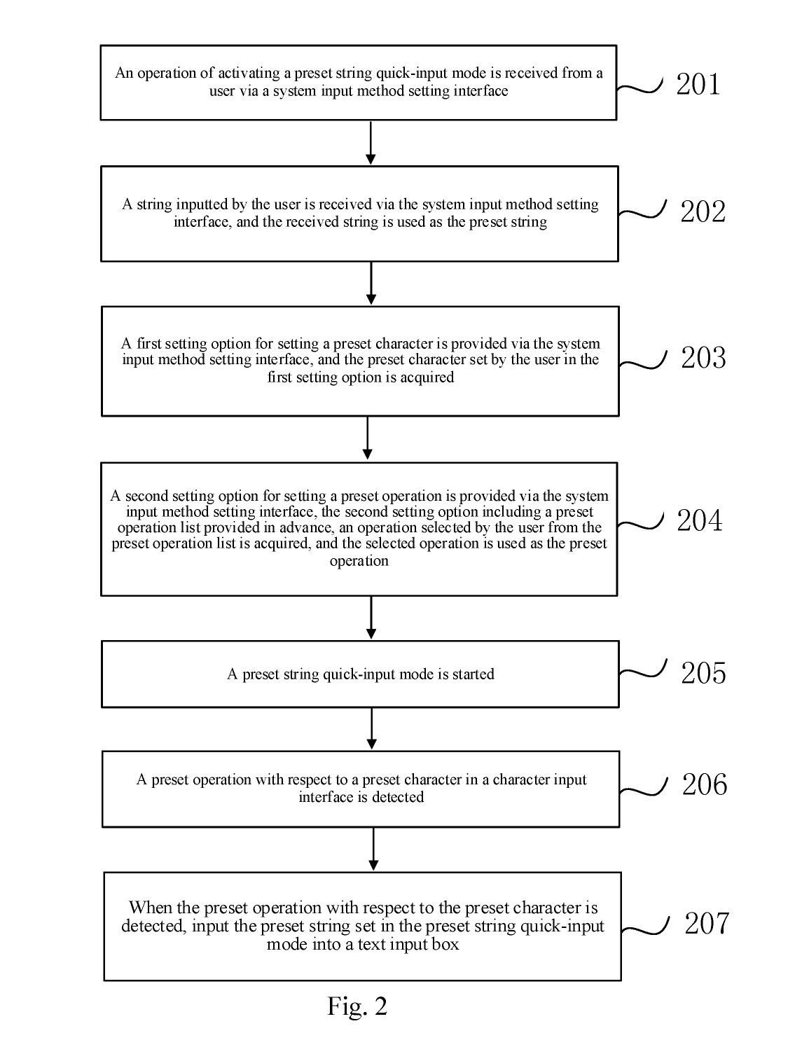

FIG. 2 is a flow chart of another method for inputting text, according to an exemplary embodiment. As shown in FIG. 2, the method is implemented by a terminal device, and includes the following steps.

In step 201, an operation of activating a preset string quick-input mode is received from a user via a system input method setting interface.

In step 202, a string inputted by the user is received via the system input method setting interface, and the received string is used as the preset string.

In step 203, a first setting option for setting a preset character is provided via the system input method setting interface, and the preset character set by the user in the first setting option is acquired.

In step 204, a second setting option for setting a preset operation is provided via the system input method setting interface, the second setting option including a preset operation list provided in advance, an operation selected by the user from the preset operation list is acquired, and the selected operation is used as the preset operation.

In step 205, a preset string quick-input mode is started.

In step 206, a preset operation with respect to a preset character in a character input interface is detected.

In step 207, when the preset operation with respect to the preset character is detected, a preset string set in the preset string quick-input mode is inputted into a text entry box.

Hereinafter, by an application example in combination with the above application scenario, the detailed explanations of the technical solutions in the above embodiments are given.

In the present embodiment, the above preset character may be “@” character on the virtual on-screen keyboard, the above preset string may be an email address used by the user as the login account, and the above preset operation may be a long-press operation.

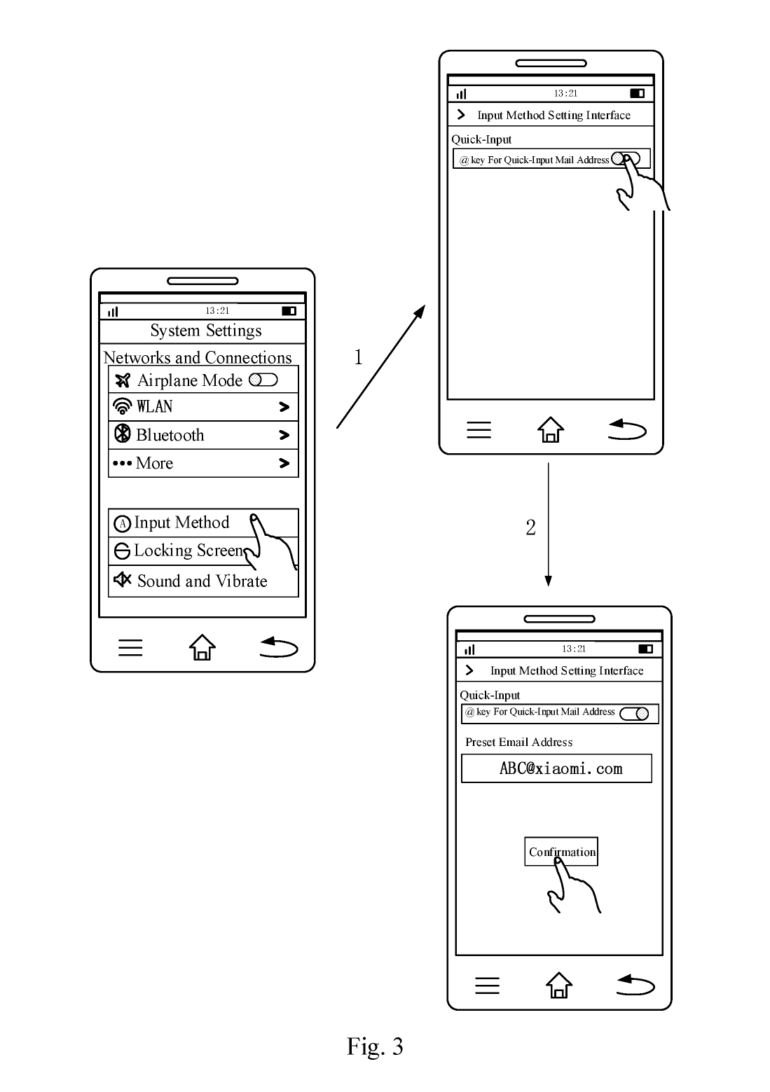

FIG. 3 is a schematic diagram of setting a string quick-input mode by a user, according to an exemplary embodiment.

As shown in FIG. 3, in a system setting interface, an “Input Method” setting option may be included. The user may touch this setting option button to trigger the system to jump to the system input method setting interface.

In the system input method setting interface, a function option of “@ key for quick-input email address” may be included. The user may touch an open switch of the function option to turn on the string quick-input mode, and trigger the system to output an input box for setting a reserved string to the user, then the user may set a quick-input email address in the input box.

In the input method setting interface, a confirmation button may be included. After inputting a quick-input email address in the input box, the user may touch the confirmation button to start the string quick-input mode.

After activating the string quick-input mode, when the user inputs an email address in a login interface of an application, he/she may quickly input the email address by long pressing @ character on the virtual on-screen keyboard.

The system of the mobile terminal may monitor in real time the touch event with respect to the virtual on-screen keyboard by the user in the background. When a long-press event to @ character on the virtual on-screen keyboard by the user is monitored, the system may immediately retrieve the quick-input email address having been set by the user in the background, and then automatically fill the email address into a user name input box in the login interface, so as to complete the quick-input of the login name.

Corresponding to the embodiments relating to the above method for inputting text, the present disclosure also provides embodiments relating to device.

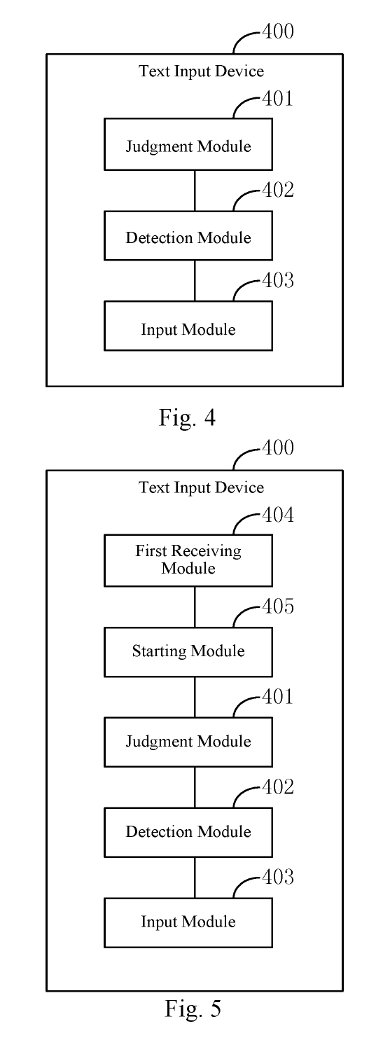

FIG. 4 is a block diagram of a text input device, according to an exemplary embodiment.

As shown in FIG. 4, a text input device 400 illustrated according to an exemplary embodiment includes a judgment module 401, a detection module 402, and an input module 403.

The judgment module 401 is configured to judge whether a preset string quick-input mode is activated for characters to be typed into the text entry box.

The detection module 402 is configured to, detect whether a preset operation with respect to a preset character is received via a character input interface, in response to judging that the preset string quick-input mode is activated.

The input module 403 is configured to, retrieve a preset string and inputting the preset string into the text entry box, in response to detecting that the preset operation with respect to the preset character is received.

FIG. 5 is a block diagram of another device, according to an exemplary embodiment. As shown in FIG. 5, on the basis of the above embodiment shown in FIG. 4, the device 400 in the present embodiment further includes a first receiving module 404 and a starting module 405.

The first receiving module 404 is configured to receive an operation of activating the preset string quick-input mode from a user via a system input method setting interface.

The starting module 405 is configured to activate the preset string quick-input mode.

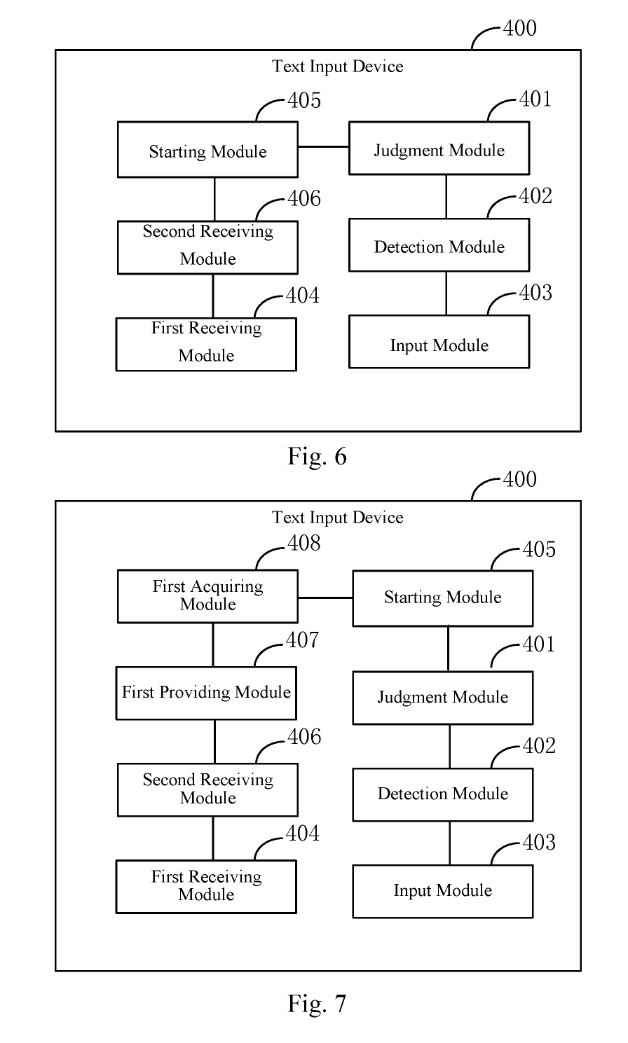

FIG. 6 is a block diagram of yet another text input device, according to an exemplary embodiment. As shown in FIG. 6, on the basis of the above embodiment shown in FIG. 5, the device 400 in the present embodiment may further include a second receiving module 406.

The second receiving module 406 is configured to, after receiving the operation of activating the preset string quick-input mode via the system input method setting interface by the user, receive an inputted string via the system input method setting interface by the user, and use the received string as the preset string.

It should be explained, the structure of the second receiving module 406 shown in the above device embodiment in FIG. 6 may also be included in the above device embodiment in FIG. 4, which is not restricted by the present disclosure.

FIG. 7 is a block diagram of another text input device, according to an exemplary embodiment. As shown in FIG. 7, on the basis of the above embodiment shown in FIG. 5, the device 400 in the present embodiment may further include a first providing module 407 and a first acquiring module 408.

The first providing module 407 is configured to, after receiving the operation of activating the preset string quick-input mode via the system input method setting interface by the user, provide a first setting option for setting the preset character via the system input method setting interface.

The first acquiring module 408 is configured to receive a preset character set by the user in the first setting option.

It should be explained, the structures of the first providing module 407 and the first acquiring module 408 shown in the above device embodiment in FIG. 7 may also be included in the above device embodiments in FIGS. 4 and 6, which is not restricted by the present disclosure.

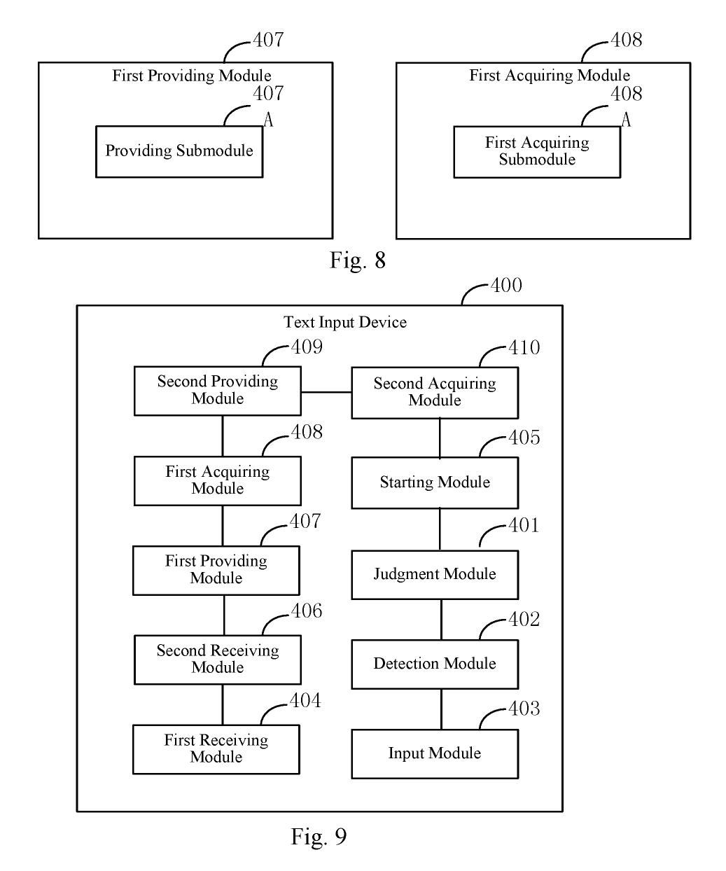

FIG. 8 is a block diagram of another text input device, according to an exemplary embodiment. As shown in FIG. 8, on the basis of the above embodiment shown in FIG. 7, the first providing module 407 may include a providing submodule 407A, and the first acquiring module 408 may include a first acquiring submodule 408A.

The providing submodule 407A is configured to, after receiving the operation of activating the preset string quick-input mode via the system input method setting interface by the user, provide a preset character list via the system input method setting interface, preset characters in the preset character list being obtained based on an input habit of the user and a keyboard layout of the character input interface.

The first acquiring submodule 408A is configured to acquire a character selected by the user from the preset character list, and use the selected character as the preset character.

It should be explained, the structures of the providing submodule 407A and the first acquiring submodule 408A shown in the above device embodiment in FIG. 8 may also be included in the above device embodiments in FIGS. 4 and 6, which is not restricted by the present disclosure.

FIG. 9 is a block diagram of yet another text input device, according to an exemplary embodiment. As shown in FIG. 9, on the basis of the above embodiment shown in FIG. 5, the device 400 in the present embodiment may further include a second providing module 409 and a second acquiring module 410.

The second providing module 409 is configured to, after receiving the operation of activating the preset string quick-input mode via the system input method setting interface by the user, provide a second setting option for setting the preset operation via the system input method setting interface, the second setting option including a preset operation list provided in advance.

The second acquiring module 410 is configured to acquire an operation selected by the user from the preset operation list, and use the selected operation as the preset operation.

It should be explained, the structures of the second providing module 409 and the second acquiring module 410 shown in the above device embodiment in FIG. 9 may also be included in the above device embodiments in FIGS. 4 and 6-8, which is not restricted by the present disclosure.

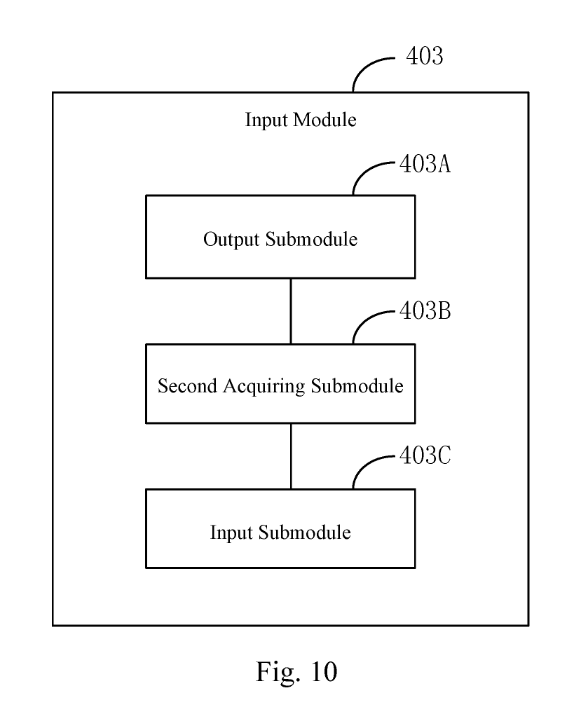

FIG. 10 is a block diagram of still yet another text input device, according to an exemplary embodiment. As shown in FIG. 10, on the basis of the above embodiment shown in FIG. 4, when a plurality preset strings are set in the preset string quick-input mode, the input module 403 may include an output submodule 403A, a second acquiring submodule 403B and an input submodule 403C.

The output submodule 403A is configured to, when a preset operation with respect to a preset character is detected, output the plurality of preset strings in a preset position of a text entry box.

The second acquiring submodule 403B is configured to acquire a preset string selected by the user.

The input submodule 403C is configured to input the preset string selected by the user into the text entry box.

It should be explained, the structures of the output submodule 403A, the second acquiring submodule 403B and the input submodule 403C shown in the above device embodiment in FIG. 10 may also be included in the above device embodiments in FIGS. 5 and 9, which is not restricted by the present disclosure.

With respect to the devices in the above embodiments, the specific manners for performing operations for individual modules therein have been described in detail in the embodiments regarding the methods, which will not be elaborated herein.

For device embodiments, since the device embodiments are substantially corresponding to the method embodiments, the relevant contents may be referred to some explanations in the method embodiments. The units illustrated as separate components may be or may not be separated physically, the component used as a unit display may be or may not be a physical unit, i.e., may be located at one location, or may be distributed into multiple network units. A part or all of the modules may be selected to achieve the purpose of the solution in the present disclosure according to actual requirements. The person skilled in the art can understand and implement the present disclosure without paying inventive labor.

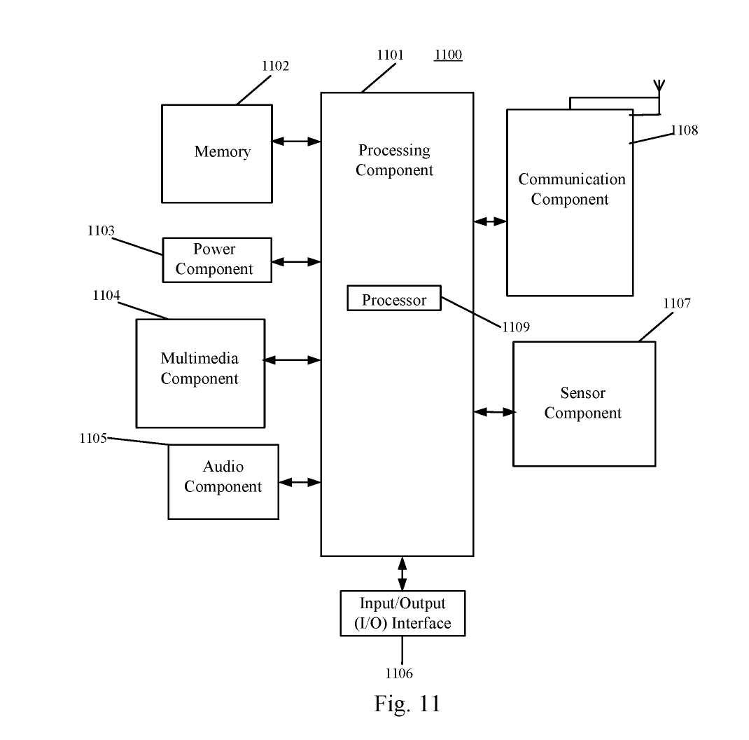

FIG. 11 is a block schematic diagram of a text input device, according to an exemplary embodiment.

As shown in FIG. 11, a device 1100 for inputting text according to an exemplary embodiment is illustrated. The device 1100 may be a mobile phone, a computer, a digital broadcast terminal, a messaging device, a gaming console, a tablet, a medical device, exercise equipment, a personal digital assistant, and the like.

Referring to FIG. 11, the device 1100 may include one or more of the following components: a processing component 1101, a memory 1102, a power component 1103, a multimedia component 1104, an audio component 1105, an input/output (I/O) interface 1106, a sensor component 1107, and a communication component 1108.

The processing component 1101 typically controls overall operations of the device 1100, such as the operations associated with display, telephone calls, data communications, camera operations, and recording operations. The processing component 1101 may include one or more processors 1109 to execute instructions to perform all or part of the steps in the above described methods. Moreover, the processing component 1101 may include one or more modules which facilitate the interaction between the processing component 1101 and other components. For instance, the processing component 1101 may include a multimedia module to facilitate the interaction between the multimedia component 1104 and the processing component 1101.

The memory 1102 is configured to store various types of data to support the operation of the device 1100. Examples of such data include instructions for any applications or methods operated on the device 1100, contact data, phonebook data, messages, pictures, video, etc. The memory 1102 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1103 provides power to various components of the device 1100. The power component 1103 may include a power management system, one or more power sources, and any other components associated with the generation, management, and distribution of power in the device 1100.

The multimedia component 1104 includes a screen providing an output interface between the device 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1104 includes a front camera and/or a rear camera. The front camera and the rear camera may receive an external multimedia datum while the device 1100 is in an operation mode, such as a photographing mode or a video mode. Each of the front camera and the rear camera may be a fixed optical lens system or have focus and optical zoom capability.

The audio component 1105 is configured to output and/or input audio signals. For example, the audio component 1105 includes a microphone (“MIC”) configured to receive an external audio signal when the device 1100 is in an operation mode, such as a call mode, a recording mode, and a voice recognition mode. The received audio signal may be further stored in the memory 1102 or transmitted via the communication component 1108. In some embodiments, the audio component 1105 further includes a speaker to output audio signals.

The I/O interface 1106 provides an interface between the processing component 1101 and peripheral interface modules, such as a keyboard, a click wheel, buttons, and the like. The buttons may include, but are not limited to, a home button, a volume button, a starting button, and a locking button.

The sensor component 1107 includes one or more sensors to provide status assessments of various aspects of the device 1100. For instance, the sensor component 1107 may detect an open/closed status of the device 1100, relative positioning of components, e.g., the display and the keypad, of the device 1100, a change in position of the device 1100 or a component of the device 1100, a presence or absence of user contact with the device 1100, an orientation or an acceleration/deceleration of the device 1100, and a change in temperature of the device 1100. The sensor component 1107 may include a proximity sensor configured to detect the presence of nearby objects without any physical contact. The sensor component 1107 may also include a light sensor, such as a CMOS or CCD image sensor, for use in imaging applications. In some embodiments, the sensor component 1107 may also include an accelerometer sensor, a gyroscope sensor, a magnetic sensor, a pressure sensor, or a temperature sensor.

The communication component 1108 is configured to facilitate communication, wired or wirelessly, between the device 1100 and other devices. The device 1100 can access a wireless network based on a communication standard, such as WiFi, 2G, or 3G, or a combination thereof In one exemplary embodiment, the communication component 1108 receives a broadcast signal or broadcast associated information from an external broadcast management system via a broadcast channel. In one exemplary embodiment, the communication component 1108 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1102, executable by the processor 1109 in the device 1100, for performing the above-described methods. For example, the non-transitory computer-readable storage medium may be a ROM, a RAM, a CD-ROM, a magnetic tape, a floppy disc, an optical data storage device, and the like.

When the instructions in the storage medium are carried out by the processor of the mobile terminal, the mobile terminal is enabled to perform the methods described above.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for inputting text into a text entry box, comprising:
displaying the text entry box and judging whether a preset string quick-input mode is activated for characters to be typed into the text entry box;
detecting whether a preset operation with respect to a preset character is received via a character input interface, in response to judging that the preset string quick-input mode is activated; and
retrieving a preset string and inputting the preset string into the text entry box, in response to detecting that the preset operation with respect to the preset character is received,
wherein a correspondence between the preset string and the preset operation with respect to the preset character is defined in the preset string quick-input mode.

2. The method of claim 1, further comprising:
receiving, from a user, an operation of activating the preset string quick-input mode via a system input method setting interface; and
activating the preset string quick-input mode.

3. The method of claim 2, further comprising:
after receiving the operation of activating the preset string quick-input mode, receiving a string inputted via the system input method setting interface, and using the received string as the preset string.

4. The method of claim 2, further comprising:
after receiving the operation of activating the preset string quick-input mode, providing a first setting option for setting the preset character via the system input method setting interface; and
acquiring the preset character set in the first setting option.

5. The method of claim 4, wherein providing the first setting option for setting the preset character via the system input method setting interface comprises:
providing a preset character list via the system input method setting interface, wherein the preset character list includes at least one preset character obtained based on an input habit of a user and a keyboard layout of the character input interface; and
acquiring the preset character set in the first setting option comprises:
acquiring a character selected from the preset character list, and using the selected character as the preset character.

6. The method of claim 2, further comprising:
after receiving the operation of activating the preset string quick-input mode, providing a second setting option for setting the preset operation via the system input method setting interface, the second setting option including a preset operation list provided in advance; and
acquiring an operation selected from the preset operation list, and using the selected operation as the preset operation.

7. The method of claim 1, wherein a plurality of preset strings are set in the preset string quick-input mode, and inputting the preset string into the text entry box comprises:
outputting the plurality of preset strings in a preset position of the text entry box;
acquiring a preset string selected by a user; and
inputting the preset string selected by the user into the text entry box.

8. A device for inputting text into a text entry box, comprising:
a processor; and
a memory for storing instructions executable by the processor,
wherein the processor is configured to perform:
displaying the text entry box and judging whether a preset string quick-input mode is activated for characters to be typed into the text entry box;
detecting whether a preset operation with respect to a preset character is received via a character input interface, in response to judging that the preset string quick-input mode is activated; and
retrieving a preset string and inputting the preset string into the text entry box, in response to detecting that the preset operation with respect to the preset character is received,
wherein a correspondence between the preset string and the preset operation with respect to the preset character is defined in the preset string quick-input mode.

9. The device of claim 8, wherein the processor is further configured to perform:
receiving, from a user, an operation of activating the preset string quick-input mode via a system input method setting interface; and
activating the preset string quick-input mode.

10. The device of claim 9, wherein the processor is further configured to perform:
after receiving the operation of activating the preset string quick-input mode, receiving a string inputted via the system input method setting interface, and using the received string as the preset string.

11. The device of claim 9, wherein the processor is further configured to perform:
after receiving the operation of activating the preset string quick-input mode, providing a first setting option for setting the preset character via the system input method setting interface; and
acquiring the preset character set in the first setting option.

12. The device of claim 11, wherein providing the first setting option for setting the preset character via the system input method setting interface comprises:
providing a preset character list via the system input method setting interface, wherein the preset character list includes at least one preset character obtained based on an input habit of a user and a keyboard layout of the character input interface; and
acquiring the preset character set in the first setting option comprises:
acquiring a character selected from the preset character list, and using the selected character as the preset character.

13. The device of claim 9, wherein the processor is further configured to perform:
after receiving the operation of activating the preset string quick-input mode, providing a second setting option for setting the preset operation via the system input method setting interface, the second setting option including a preset operation list provided in advance; and
acquiring an operation selected from the preset operation list, and using the selected operation as the preset operation.

14. The device of claim 8, wherein a plurality of preset strings are set in the preset string quick-input mode, and inputting the preset string into the text entry box comprises:
outputting the plurality of preset strings in a preset position of the text entry box;
acquiring a preset string selected by a user; and
inputting the preset string selected by the user into the text entry box.

15. A non-transitory readable storage medium comprising instructions, executable by a processor in a device, for performing a method for inputting text into a text entry box, the method comprising:
displaying the text entry box and judging whether a preset string quick-input mode is activated for characters to be typed into the text entry box;
detecting whether a preset operation with respect to a preset character is received via a character input interface, in response to judging that the preset string quick-input mode is activated; and
retrieving a preset string and inputting the preset string into the text entry box, in response to detecting that the preset operation with respect to the preset character is received,
wherein a correspondence between the preset string and the preset operation with respect to the preset character is defined in the preset string quick-input mode.
